(19) United States
(12) Patent Application Publication
(10) Pub. No.: US 2015/0160438 A1
(43) Pub. Date: Jun. 11, 2015

(54) IMAGING APPARATUS HAVING BENDING OPTICAL ELEMENT

(71) Applicant: HOYA CORPORATION, Tokyo (JP)

(72) Inventor: Isao OKUDA, Saitama (JP)

(73) Assignee: HOYA CORPORATION, Tokyo (JP)

(21) Appl. No.: 14/559,028

(22) Filed: Dec. 3, 2014

(30) Foreign Application Priority Data
Dec. 10, 2013 (JP) 2013-254693

(51) Int. Cl. G02B 13/00; G02B 27/64

(52) U.S. Cl. CPC G02B 13/0015; G02B 27/646

(57) ABSTRACT

An imaging apparatus includes a bending optical element, a front lens group and a rear lens group. The front lens group and the rear lens group are provided on a pre-bending optical axis and a post-bending optical axis of the bending optical element, respectively. The front lens group includes a cut surface formed as an inclined flat surface on an outer edge of the front lens group on a side near the rear lens group, the inclined flat surface lying on a plane orthogonal to a first reference plane, which includes the pre-bending and post-bending optical axes. The inclined flat surface is inclined to a second reference plane, which is orthogonal to the first reference plane and includes the post-bending optical axis, to approach the second reference plane in a direction from an incident surface of the front lens group to an exit surface thereof.

### BACKGROUND OF THE INVENTION

1. Field of the Invention

The present invention relates to an imaging apparatus which includes a bending optical element, a front lens group and a rear lens group, wherein the front lens group and the rear lens group are provided on a pre-bending optical axis and a post-bending optical axis of the bending optical element, respectively.

2. Description of the Related Art

In recent years, mobile electronic devices which are designed mainly for taking still/moving photographic images, such as digital cameras (still-video cameras) and digital camcorders (motion-video cameras), and other mobile electronic devices which are designed to be capable of taking such photographic images as a subsidiary function, such as mobile phones equipped with a camera and tablet computers (smart devices), etc., equipped with a camera, have become widespread, and there has been a demand to miniaturize the imaging units incorporated in these types of mobile electronic devices. In order to miniaturize an imaging unit, it is known to configure an optical system of an imaging unit as a bending optical system which reflects (bends) a light bundle using a reflection surface of a reflecting element (bending optical element) such as a prism or a mirror. An imaging optical system having at least one bending optical element (hereinafter also referred to as an “imaging apparatus”) is advantageous in achieving a reduction in thickness of the imaging unit, especially in the travelling direction of the incident light emanating from an object to be photographed.

Such an imaging apparatus is known in the art, in which a front lens group and a rear lens group are disposed on a pre-bending optical axis and a post-bending optical axis of the bending optical element, and the front lens group is formed of a negative lens element (a lens element having a concave surface on the bending optical element side) (disclosed in Japanese Unexamined Patent Publication Nos. 2004-355010 and 2007-219199). In addition, in Japanese Unexamined Patent Publication No. 2007-219199, a cut surface which lies in a plane orthogonal to the post-bending optical axis (a surface at a right -angle to the post-bending optical axis without intersecting the post-bending optical axis) is formed on part of the outer edge of the front lens group on a side thereof that is closest to the rear lens group so that the front lens group and the rear lens group can be disposed as close to each other as possible without interfering with each other (in other words, the front lens group is formed into a D-cut lens).

Further examples of the related art are also disclosed in Japanese Unexamined Patent Publication Nos. 2006-267391, 2010-243763 and 2013-105049.

However, according to the inventor of the present invention, there is still room for downsizing (miniaturizing) conventional imaging apparatuses like the imaging apparatus disclosed in Japanese Unexamined Patent Publication No. 2007-219199, in which the front lens group that is positioned optically in front of a bending optical element is configured of a D-cut lens element. Specifically, in the imaging apparatus which has been currently being developed by the applicant of the present invention in which the front lens group is driven as an anti-shake (image-stabilizing) lens group, it has been required to downsize (miniaturize) the glass front lens group and reduce the weight thereof as much as possible.

### SUMMARY OF THE INVENTION

The present invention provides an imaging apparatus which includes a bending optical element, a front lens group and a rear lens group, wherein the front lens group and the rear lens group lie on the pre-bending optical axis and the post-bending optical axis of the bending optical element, respectively, and wherein the imaging apparatus makes it possible to achieve further miniaturization and reduction in weight of the front lens group.

The present invention has been devised in consideration of the above viewpoint that further miniaturization and reduction in weight of the front lens group is possible if the cut surface of the front lens group is formed as a flat surface inclined to the optical axis of the front lens group, whereas the cut surface of a conventional D-cut lens is simply formed as a flat surface parallel to the optical axis of the front lens group.

According to an aspect of the present invention, an imaging apparatus is provided, including a bending optical element, a front lens group and a rear lens group. The front lens group and the rear lens group are provided on a pre-bending optical axis and a post-bending optical axis of the bending optical element, respectively. The front lens group includes a cut surface which is formed as an inclined flat surface on a portion of an outer edge of the front lens group on a side near the rear lens group, the inclined flat surface lying on a plane that is orthogonal to a first reference plane, which includes the pre-bending optical axis and the post-bending optical axis. The inclined flat surface is inclined to a second reference plane, which is orthogonal to the first reference plane and includes the pre-bending optical axis, to approach the second reference plane in a direction from an incident surface of the front lens group to an exit surface thereof.

Accordingly, both miniaturization and reduction in weight of the front lens group to the limit can be achieved.

It is desirable for an angle between the inclined flat surface and the second reference plane to be in a range of 10 through 30 degrees in the first reference plane.

It is desirable for the rear lens group to include an immediately-rearward lens element which is positioned immediately behind the bending optical element, and for an angle between an edge surface of the immediately-rearward lens element and the second reference plane to be one of equal to and smaller than 90 degrees in the first reference plane.

The configuration of the front lens group formed as a glass lens element enhances the effect of miniaturizing the front lens group.

It is desirable for the outer edge of the front lens group except the portion thereof to be formed as a partial-cylindrical surface about the optical axis of the front lens group.

It is desirable for the inclined flat surface and each of the incident surface and the exit surface of the front lens group to directly intersect with each other without an inclined chamfered surface therebetween. A linear border is defined between the inclined flat surface and the incident surface of the front lens group and a linear border is defined between the inclined flat surface and the exit surface of the front lens group.

Forming a chamfer(s) is disadvantageous with respect to miniaturization (reduction in diameter) because no light rays can pass through a chamfer (namely, a chamfer cannot be made to serve as an effective optical surface for image formation). In other words, the above-described structure makes it possible to enlarge the effective optical surface of the front lens group up to the immediate area of the cut surface, thus contributing to miniaturization (reduction in diameter).

Since the front lens group can be reduced in weight, the imaging apparatus according to the present invention is suitable particularly for the case where the imaging apparatus incorporates an anti-shake system which drives the front lens group in directions intersecting the pre-bending optical axis, the directions including a direction component that is orthogonal to the pre-bending optical axis.

It is desirable for the front lens group to consist of a single lens element having a concave exit surface.

The present disclosure relates to subject matter contained in Japanese Patent Application No. 2013-254693 (filed on Dec. 10, 2013) which is expressly incorporated herein by reference in its entirety.

### BRIEF DESCRIPTION OF THE DRAWINGS

The present invention will be described below in detail with reference to the accompanying drawings in which:

FIG. 1 is an external perspective view of an embodiment of an imaging apparatus (imaging unit) according to the present invention;

FIG. 2 is a perspective view of the imaging unit, illustrating an internal structure thereof;

FIG. 3 is a transverse sectional view of the imaging unit, taken along the lengthwise direction thereof;

FIG. 4 is an exploded perspective view of a first lens-group unit which constitutes part of the imaging unit;

FIG. 5 is a perspective view of a first lens frame, guide shafts and coils which constitute main components of the first lens-group unit of the imaging unit, illustrating the positional relationship between these elements;

FIG. 6 is an exploded perspective view of the first lens frame, the guide shafts and the coils shown in FIG. 5;

FIG. 7 is a front elevational view of the first lens-group unit with a covering member removed, viewed from the object side;

FIG. 8 is a sectional view of the first lens-group unit, taken along the line VIII-VIII shown in FIG. 7;

FIG. 9 is a sectional view of the first lens-group unit, taken along the line IX-IX shown in FIG. 7;

FIG. 10 is a sectional view taken along the line X-X shown in FIG. 7, illustrating a portion of an electromagnetic actuator provided in the first lens-group unit, and the vicinity thereof, with the covering member mounted;

FIG. 11 is a sectional view taken along the line XI-XI shown in FIG. 7, illustrating another portion of the electromagnetic actuator, and the vicinity thereof, with the covering member mounted;

FIGS. 12A, 12B, 12C and 12D are perspective views of the first lens element of the first lens-group unit of the imaging unit, viewed from different directions; and

FIG. 13 is an enlarged sectional view of the first lens-group unit with the covering member removed, taken along a first reference plane which passes through the pre-bending optical axis and the post-bending optical axis of a bending optical element.

### DESCRIPTION OF THE EMBODIMENT

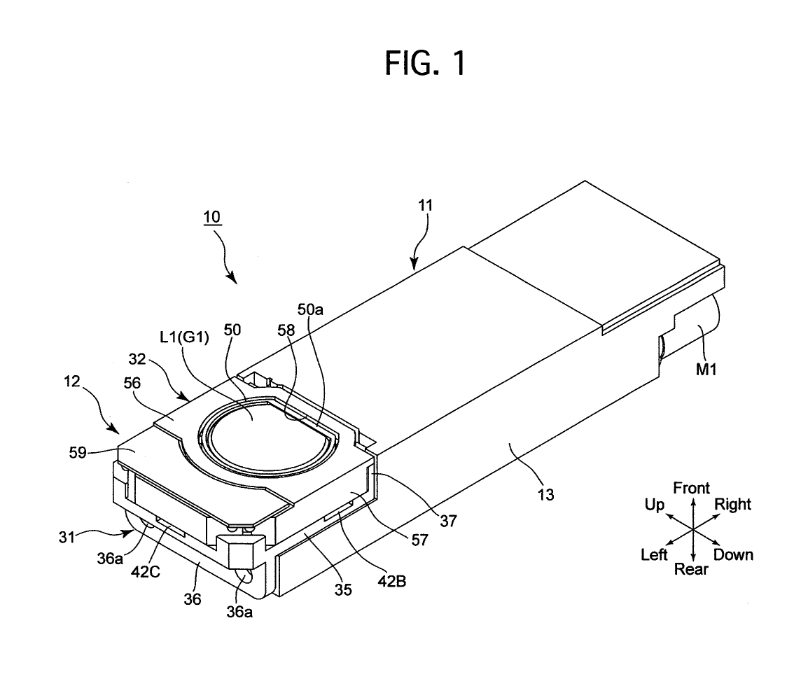

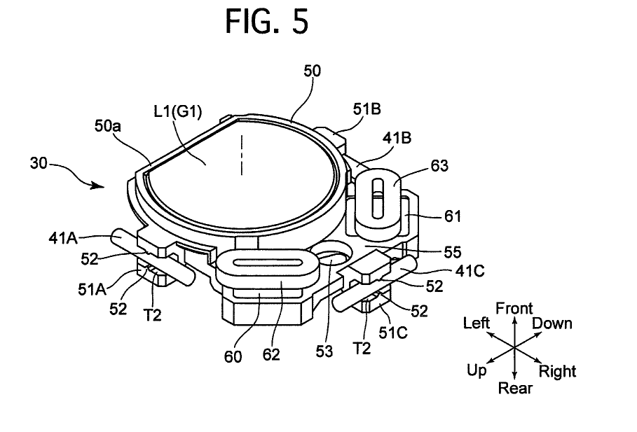

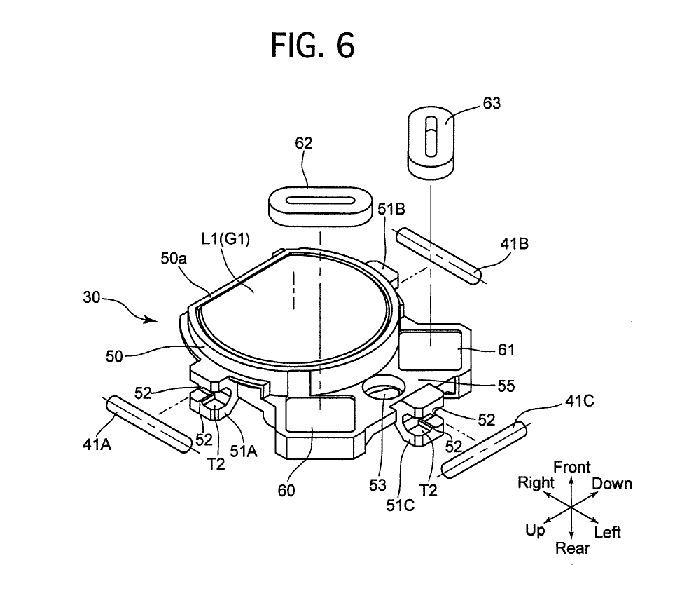

An embodiment of an imaging unit (imaging apparatus having at least one bending optical element) 10 according to the present invention will be discussed below with reference to FIGS. 1 through 13. In the following descriptions, forward and rearward directions, leftward and rightward directions, and upward and downward directions are determined with reference to the directions of the double-headed arrows shown in FIGS. 1 through 11. The object side corresponds to the front side. As shown by the outward appearance of the imaging unit 10 in FIG. 1, the imaging unit 10 has a laterally elongated shape which is slim in the forward/rearward direction and long in the leftward/rightward direction.

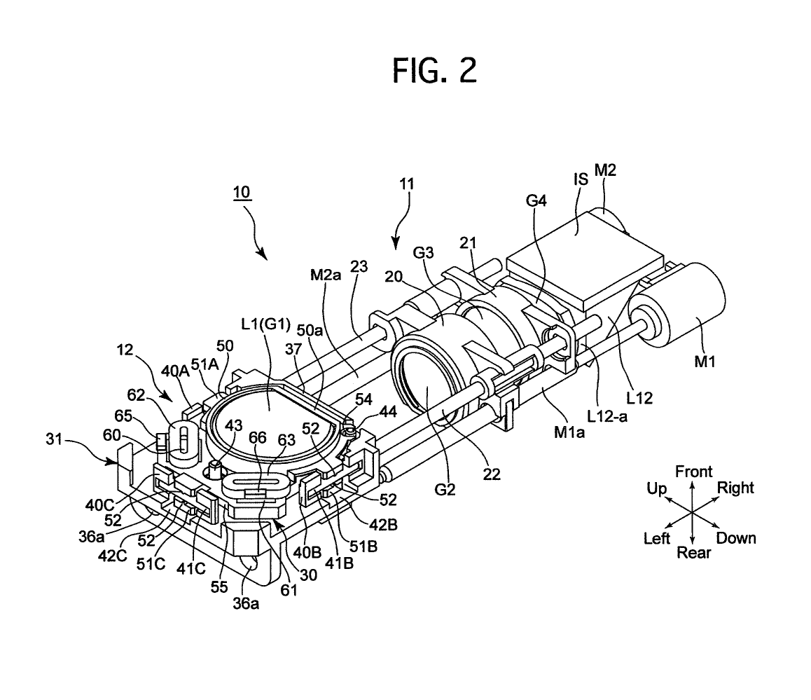

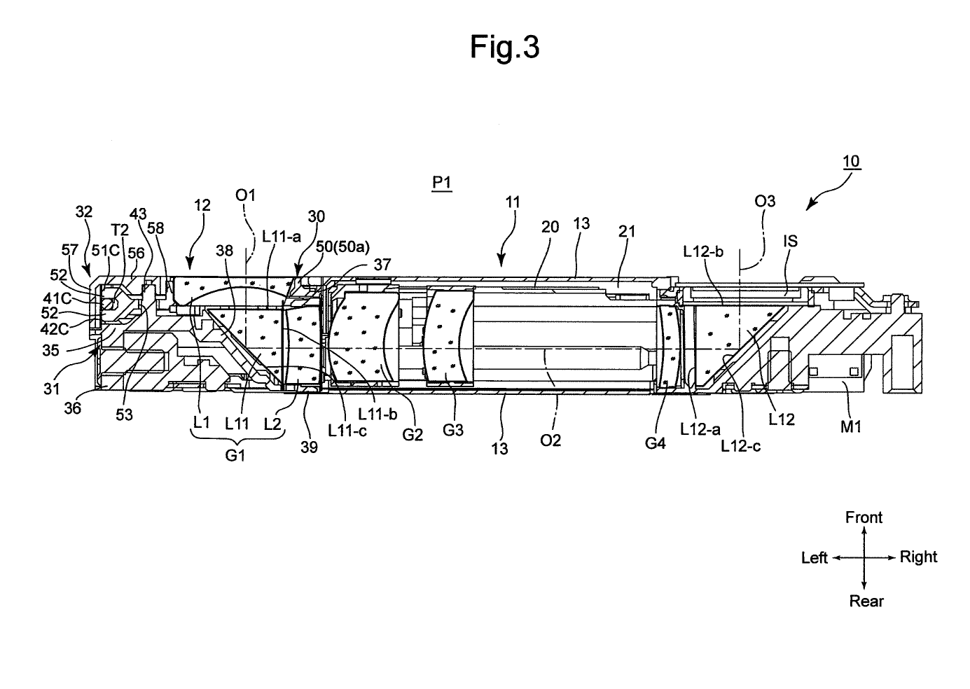

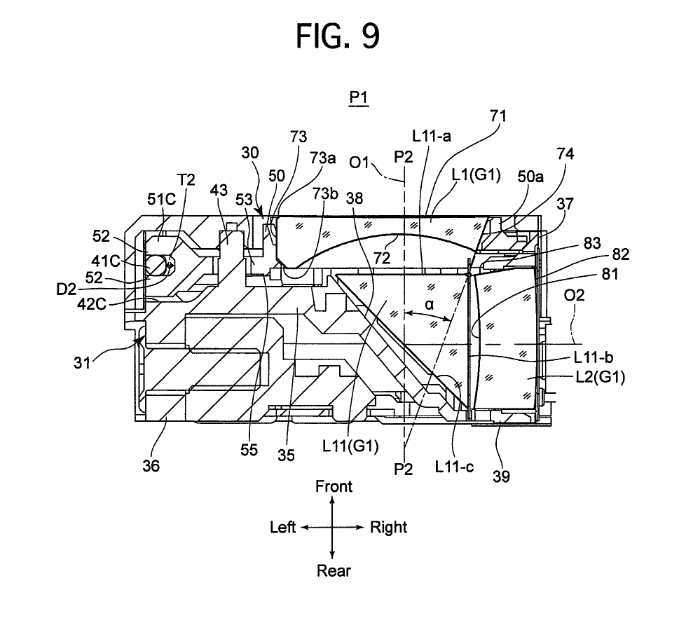

As shown in FIGS. 2 and 3, the imaging unit 10 has an imaging optical system which is provided with a first lens group G1, a second lens group (rear lens group) G2, a third lens group (rear lens group) G3 and a fourth lens group (rear lens group) G4. The first lens group G1 is provided with a first prism (bending optical element) L11, and the imaging unit 10 is provided with a second prism L12 on the right-hand side (image plane side) of the fourth lens group G4. The imaging optical system of the imaging unit 10 is configured as a bending optical system which reflects (bends) a light bundle at substantially right angles at each of the first prism L11 and the second prism L12. As shown in FIGS. 3 and 9, the first lens group G1 is configured of a first lens element (front lens group) L1, the first prism L11 and a second lens element (rear lens group, immediately-rearward lens element) L2. The first lens element L1 is positioned in front of (on the object side of) an incident surface L11-a of the first prism L11, while the second lens element L2 is positioned on the right-hand side (image plane side) of an exit surface L11-b of the first prism L11 (i.e., positioned immediately behind the bending optical element). Each of the second lens group G2, the third lens group G3 and the fourth lens group G4 is a lens group including no bending optical element such as a prism.

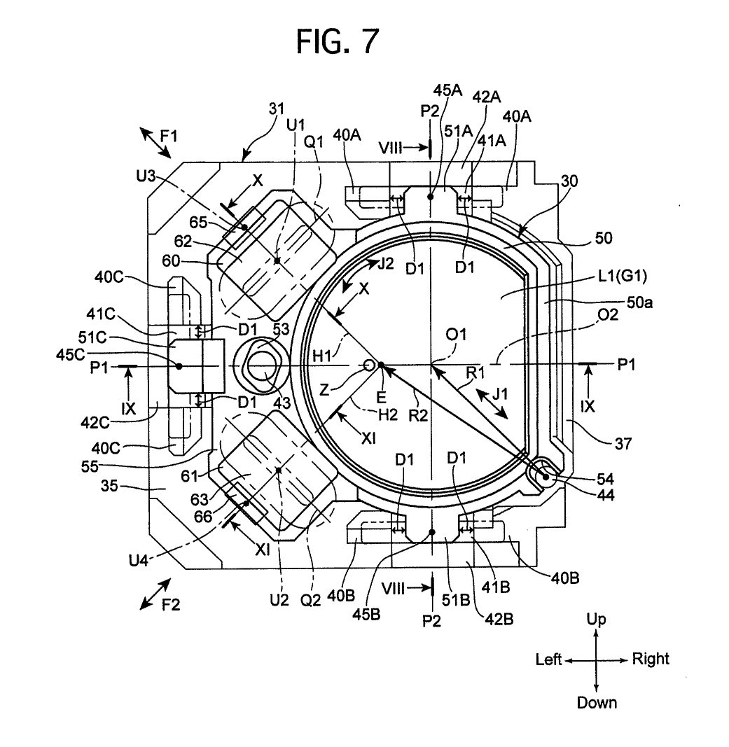

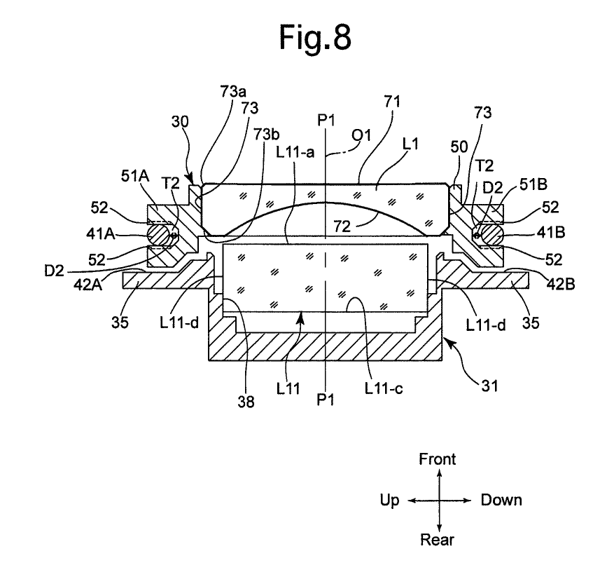

As shown in FIG. 3, a light bundle emanating from the photographic object and incident on the first lens element L1 along a pre-bending optical axis (first optical axis) O1 extending in the rearward direction from the front of the imaging unit 10 enters the first prism L11 through the incident surface L11-a and is reflected by a reflecting surface L11-c of the first prism L11 in a direction along a post-bending optical axis (second optical axis) O2 (extending in the rightward direction) to exit from the exit surface L11-b of the first prism L11. Subsequently, the light bundle exiting from the exit surface L11-b passes through the second lens element L2 of the first lens group G1 and the second through fourth lens groups G2, G3 and G4, which lie on the post-bending optical axis O2, and is incident on the second prism L12 through an incident surface L12-a thereof. Subsequently, the light bundle which is passed through the incident surface L12-a is reflected by a reflecting surface L12-c of the second prism L12 in a direction along a third optical axis O3 (extending in the forward direction) and is incident on the imaging surface of an image sensor IS to form an object image thereon. The pre-bending optical axis O1 and the third optical axis O3 are substantially parallel to each other and lie, together with the post-bending optical axis O2, on a common plane. This common (imaginary) plane defines a first reference plane (plane including both the pre-bending optical axis O1 and the post-bending optical axis O2) P1 (see FIGS. 7 and 8) in which the pre-bending optical axis O1, the post-bending optical axis O2 and the third optical axis O3 lie, and an imaginary plane which is orthogonal to the first reference plane P1 and includes the pre-bending optical axis O1 is represented by a second reference plane P2 (see FIGS. 7 and 9). The imaging unit 10 has a shape elongated in a direction along the post-bending optical axis O2, and the first lens element L1 is positioned in the vicinity of an end (the left end) of the imaging unit 10 in the lengthwise direction thereof.

As shown in FIGS. 1 through 3, the imaging unit 10 is provided with a body module 11 which holds the second lens group G2, the third lens group G3, the fourth lens group G4, the second prism L12 and the imaging sensor IS, and a first lens-group unit 12 which holds the first lens group G1. The body module 11 is provided with a box-shaped housing 13 which is elongated in the leftward/rightward direction and is small in thickness (slim) in the forward/rearward direction. The first lens-group unit 12 is fixed to one end (the left end) of the housing 13 in the lengthwise direction thereof, and the fourth lens group G4, the second prism L12 and the imaging sensor IS are fixedly held at the other end (the right end) of the housing 13 in the lengthwise direction thereof.

As shown in FIG. 2, the second lens group G2 and the third lens group G3 are held by a second lens group frame 20 and a third lens group frame 21, respectively, which are supported to be movable along the post-bending optical axis O2 by a pair of rods 22 and 23 provided in the housing 13. The imaging unit 10 is provided with a first motor M1 and a second motor M2 that are supported by the housing 13. When the first motor M1 is driven to rotate a screw shaft M1a thereof which projects from the body of the first motor M1, this rotation is transmitted to the second lens group frame 20 to move the second lens group frame 20 along the pair of rods 22 and 23. When the second motor M2 is driven to rotate a screw shaft M2a thereof which projects from the body of the second motor M2, this rotation is transmitted to the third lens group frame 21 to move the third lens group frame 21 along the pair of rods 22 and 23. The imaging optical system of the imaging unit 10 is a zoom lens system (variable-focal length lens system), and a zooming operation (power-varying operation) is performed by moving the second lens group G2 and the third lens group G3 along the post-bending optical axis O2. In addition, a focusing operation is performed by moving the third lens group G3 along the post-bending optical axis O2.

The imaging unit 10 is provided with an anti-shake (image shake correction/image-stabilizing/shake reduction) system that reduces image shake on an image plane which is caused by vibrations such as hand shake. This anti-shake system drives the first lens element L1 of the first lens group G1 in a plane orthogonal to the pre-bending optical axis O1. The pre-bending optical axis O1 in the following descriptions and the drawings of the present embodiment of the imaging apparatus denotes the position of the pre-bending optical axis O1 in a state where the first lens element L1 is positioned at the center of the driving range thereof by the anti-shake system (i.e., at an initial optical-design position of the first lens element L1 when no image shake correction operation is performed) (this state will be hereinafter referred to as an anti-shake initial position).

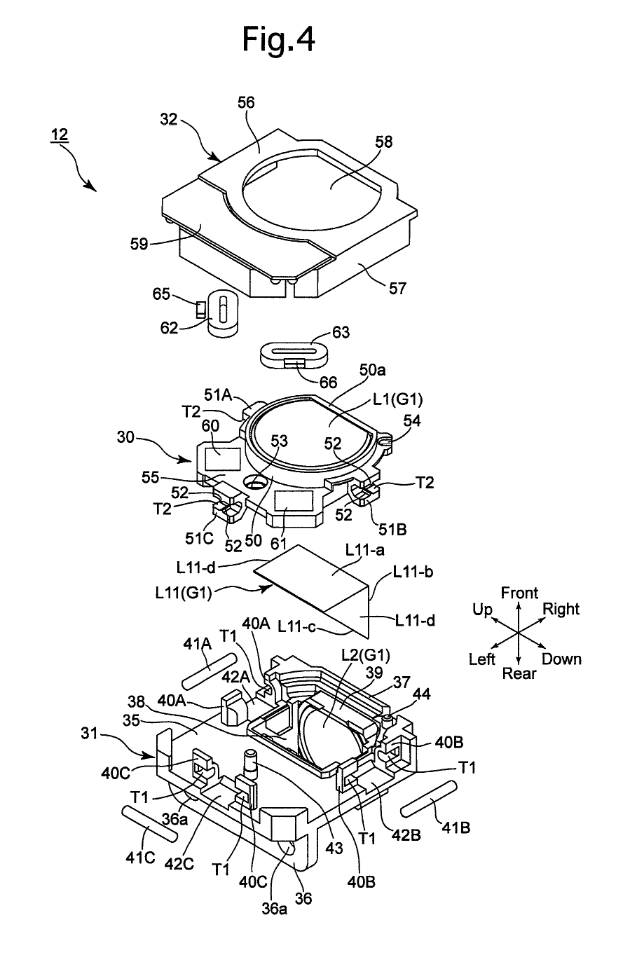

As shown in FIG. 4, the first lens-group unit 12 is provided with a first lens frame (movable frame) 30 which holds the first lens element L1, a base member 31 which holds the first prism L11 and the second lens element L2, and a cover member 32 which covers the first lens frame 30 and the base member 31 from the front (object side). The base member 31 is substantially rectangular in shape as viewed from the front and is provided with a base plate 35, a rear flange 36 and an exit-side flange 37. As shown in FIGS. 4, 8 and 9, the base plate 35 lies in a plane substantially orthogonal to the pre-bending optical axis O1, the rear flange 36 projects rearward from the base plate 35, and the exit-side flange 37 is positioned at the right end of the base plate 35. The support position of the first lens-group unit 12 on the body module 11 is determined by making the rear flange 36 and the exit-side flange 37 abut against the housing 13 and by engaging ends of the pair of rods 22 and 23 in holes formed in the exit-side flange 37 (see FIGS. 1 and 3). The first lens-group unit 12 is fixed to the body module 11 by screwing set screws which are inserted into holes 36a (see FIGS. 1, 2 and 4) formed through the rear flange 36 of the base member 31, into screw holes formed in the housing 13. The aforementioned set screws are not shown in the drawings.

As shown in FIGS. 3, 4, 8 and 9, the base member 31 is provided with a prism mounting recess 38. The front side of the prism mounting recess 38 is open and upwardly exposed at the top of the base plate 35, while the right side of the prism mounting recess 38 is open and exposed toward the exit-side flange 37. The first prism L11 is fit-engaged into the prism mounting recess 38 and fixed thereto. The first prism L11 is provided with the incident surface L11-a, the exit surface L11-b, the reflecting surface L11-c and a pair of side surfaces L11-d. The incident surface L11-a is positioned on the pre-bending optical axis O1 and faces forward, the exit surface L11-b is positioned on the post-bending optical axis O2 and faces rightward, the reflecting surface L11-c is positioned at an angle of substantially 45 degrees with respect to the incident surface L11-a and the exit surface L11-b, and the pair of side surfaces L11-d are substantially orthogonal to both the incident surface L11-a and the exit surface L11-b. The exit surface L11-b of the first prism L11 is substantially parallel to the second reference plane P2, and the pair of side surfaces L11-d are substantially parallel to the first reference plane P1. The base member 31 is further provided with a lens holding portion 39 which extends through the exit-side flange 37 in the rightward direction from the prism mounting recess 38, and the second lens element L2 is fit-engaged into the lens holding portion 39 to be held thereby.

As shown in FIG. 4, the incident surface L11-a of the first prism L11 is in the shape of a non-square rectangle which is defined by two pairs of sides (two long sides and two short sides). The first prism L11 is positioned in the prism mounting recess 38 so that the long sides (a pair of opposite sides) of the incident surface L11-a extend upward and downward and that the short sides (another pair of opposite sides) of the incident surface L11-a extend leftward and rightward. In the following descriptions, the long side of the incident surface L11-a which adjoins the exit surface L11-b (and which constitutes the boundary between the incident surface L11-a and the exit surface L11-b) is referred to as the exit long-side of the incident surface L11-a, and the long side of the incident surface L11-a that is on the opposite side of the exit long-side and far from the exit surface L11-b (and which constitutes the boundary between the incident surface L11-a and the reflecting surface L11-c) is referred to as the end long-side of the incident surface L11-a. The pair of short sides of the incident surface L11-a, which connect the exit long-side and the end long-side of the incident surface L11-a, constitute the boundaries between the incident surface L11-a and the pair of side surfaces L11-d.

The base member 31 is provided on the front of the base plate 35 with three guide support portions 40A, 40B and 40C. As viewed from the front of the imaging unit 10, as shown in FIG. 7, the guide support portions 40A and 40B are arranged at positions along the pair of side surfaces L11-d (the pair of short sides of the incident surface L11-a) of the first prism L11 and are symmetrical with respect to the first reference plane P1, and the guide support portion 40C is positioned between the end long-side of the incident surface L11-a and the left end of the base member 31. In other words, the guide support portions 40A, 40B and 40C are formed in a U-shaped area along the three sides of the incident surface L11-a except for the exit long-side thereof. As shown in FIG. 4, each of the guide support portions 40A, 40B and 40C is U-shaped in cross section and has an elongated open groove T1 that is open toward the peripheral edge of the base member 31. The elongated open grooves T1 of the guide support portions 40A and 40B are elongated grooves which are elongated in a direction substantially parallel to the short sides of the incident surface L11-a of the first prism L11, and the elongated open groove T1 of the guide support portion 40C is an elongated groove which is elongated in a direction substantially parallel to the long sides of the incident surface L11-a of the first prism L11.

Guide shafts 41A, 41B and 41C are inserted into and supported by the elongated open grooves T1 of the guide support portions 40A, 40B and 40C, respectively. The guide shafts 41A, 41B and 41C constitute a first guide portion which supports the first lens frame 30 in a manner to allow the first lens frame 30 to move relative to the base member 31. The guide shafts 41A, 41B and 41C are cylindrical columnar members which have a uniform cross section in the lengthwise direction and are made of metal, synthetic resin or the like. The elongated open groove T1 of the guide support portion 40A is open on the upper side thereof, and the guide shaft 41A is inserted into the elongated open groove T1 of the guide support portion 40A in a direction to approach the pre-bending optical axis O1 from this upper-side opening that faces upward. The elongated open groove T1 of the guide support portion 40B is open on the lower side thereof, and the guide shaft 41B is inserted into the elongated open groove T1 of the guide support portion 40B in a direction to approach the pre-bending optical axis O1 from this lower-side opening that faces downward. The elongated open groove T1 of the guide support portion 40C is open on the left side thereof, and the guide shaft 41C is inserted into the elongated open groove T1 of the guide support portion 40C in a direction to approach the pre-bending optical axis O1 from this left-side opening that faces leftward. Each guide shaft 41A, 41B and 41C can be inserted into the associated elongated open groove T1 along a plane orthogonal to the pre-bending optical axis O1, and the axes of the guide shafts 41A, 41B and 41C lie in a plane orthogonal to the pre-bending optical axis O1 with each guide shaft 41A, 41B and 41C inserted into the associated elongated open groove T1. More specifically, as shown in FIG. 7, the axes of the guide shafts 41A and the 41B are substantially parallel to the short sides (the pair of side surfaces L11-d) of the incident surface L11-a of the first prism L11 and the first reference plane P1, and the axis of the guide shaft 41A and the axis of the guide shaft 41B are substantially equi-distant from the first reference plane P1. In addition, the axis of the guide shaft 41C is substantially parallel to the long sides of the incident surface L11-a of the first prism L11 and the second reference plane P2. Furthermore, as shown in FIG. 7, the center points of the guide shafts 41A and 41B with respect to the axial direction thereof are positioned on the second reference plane P2, and the center point of the guide shaft 41C with respect to the axial direction thereof is positioned on the first reference plane P1. Cutouts (recesses) 42A, 42B and 42C are formed in central portions of the guide support portions 40A, 40B and 40C, each of which has a shape so as not to hold the associated guide shaft 41A, 41B or 41C. The cutouts 42A and 42B are positioned on the second reference plane P2, and the cutout 42C is positioned on the first reference plane P1.

The base member 31 is provided on the front of the base plate 35 with a movement limit projection 43 and a swing pivot (rotational shaft) 44, each of which projects forward. The movement limit projection 43 constitutes a limit portion which limits movement of the first lens frame 30 to define the range of movement of the first lens frame 30. As shown in FIG. 4, the movement limit projection 43 is a cylindrical columnar projection which is formed between the prism mounting recess 38 (the end long-side of the incident surface L11-a of the prism L11) and the cutout 42C. The swing pivot 44 constitutes a second guide portion which defines the moving direction of the first lens frame 30 relative to the base member 31. The swing pivot 44 is a cylindrical columnar projection which is formed near the boundary between the guide support portion 40B and the exit-side flange 37 (in the vicinity of the corner between the lower short side of the incident surface L11-a and the exit long-side of the incident surface L11-a) in the vicinity of the prism mounting recess 38.

In the anti-shake system of the imaging unit 10, the first lens frame 30 is supported by the base member 31 to be movable in a plane orthogonal to the pre-bending optical axis O1 via the three guide shafts 41A, 41B and 41C. As shown in FIGS. 4 through 7, the first lens frame 30 is provided with a cylindrical lens holding portion 50 having a lens holding opening, into which the first lens element L1 is fitted to be fixed thereto, and a flange 55 which projects from the lens holding portion 50 in a direction (leftward direction) opposite to the direction of extension of the post-bending optical axis O2. The first lens frame 30 is further provided around the lens holding portion 50 and the flange 55 with three slidable support portions 51A, 513 and 51C. As viewed from the front as shown in FIG. 7, the first lens element L1 has a D-cut shape that is formed (defined) with a portion of the outer edge (circular edge about the pre-bending optical axis 01) of the first lens element L1 cut out on the side (the right side) from which the post-bending optical axis O2 extends (by cutting off a portion of the outer edge of the first lens element L1 on the side near the second lens element L2). The lens holding portion 50 is provided on the right side thereof with a linear cut portion 50a which is substantially parallel to the second reference plane P2 so that the lens holding portion 50 has an imperfect cylindrical shape, corresponding to the outer profile of the first lens element L1. The three slidable support portions 51A, 51B and 51C are formed on the first lens frame 30 along three sides thereof except for the side on which the linear cut portion 50a of the lens holding portion 50 is formed.

More specifically, the slidable support portions 51A and 51B are formed on the periphery of the lens holding portion 50 to be symmetrical with respect to the first reference plane P1, and the slidable support portion 510 is formed at the left end of the flange 55. In the state shown in FIGS. 7 through 9, in which the first lens frame 30 is supported by the base member 31, the slidable support portion 51A is positioned above the cutout 42A, the slidable support portion 51B is positioned above the cutout 42B and the slidable support portion 51C is positioned above the cutout 42C. The cutouts 42A, 42B and 42C serve as clearance recesses which prevent the guide support portions 40A, 40B and 40C from interfering with the slidable support portions 51A, 51B and 51C, respectively, when the first lens frame 30 moves relative to the base member 31 to perform an anti-shake operation.

As shown in FIGS. 4 through 6, 8 and 9, each of the three slidable support portions 51A, 51B and 51C is U-shaped in cross section and has an elongated open groove T2 that is open toward the peripheral edge of the first lens frame 30. The elongated open grooves T2 of the slidable support portions 51A and 51B are elongated grooves which are elongated in a direction substantially parallel to the short sides of the incident surface L11-a of the first prism L11, and the elongated open groove T2 of the slidable support portion 51C is an elongated groove which is elongated in a direction substantially parallel to the long sides of the incident surface L11-a of the first prism L11. The guide shaft 41A is inserted into the elongated open groove T2 of the slidable support portion 51A from the upper-side opening of this elongated open groove that faces upward, the guide shaft 41B is inserted into the elongated open groove T2 of the slidable support portion 51B from the lower-side opening of this elongated open groove that faces downward, and the guide shaft 41C is inserted into the elongated open groove T2 of the slidable support portion 51C from the left-side opening of this elongated open groove that faces leftward. In an assembly process, it is advisable that the base member 31 and the first lens frame 30 be combined together and thereafter each guide shaft 41A, 41B and 41C be inserted into the associated elongated open groove T1 and the associated elongated open groove T2. When the first lens frame 30 is mounted on the base member 31 with the slidable support portions 51A, 51B and 51C respectively aligned with the cutouts 42A, 42B and 42C, the elongated open grooves T2 of the slidable support portions 51A, 51B and 51C are positioned relative to the elongated open grooves T1 of the guide support portions 40A, 40B and 40C such that the elongated open grooves T1 are communicatively connected to, and coaxial with, the elongated open grooves T2, respectively (each elongated open groove T2 is positioned at the midpoint of the associated elongated open groove T1 in the elongated direction thereof). In this state, the guide shaft 41A is inserted into the elongated open groove T1 of the guide support portion 40A and the elongated open groove T2 of the slidable support portion 51A in a direction to approach the pre-bending optical axis O1 from the upper-side openings of these elongated open grooves T1 and T2 that face upward. Similarly, the guide shaft 41B is inserted into the elongated open groove T1 of the guide support portion 40B and the elongated open groove T2 of the slidable support portion 51B in a direction to approach the pre-bending optical axis O1 from the lower-side openings of these elongated open grooves T1 and T2 that face downward, and the guide shaft 41C is inserted into the elongated open groove T1 of the guide support portion 40C and the elongated open groove T2 of the slidable support portion 51C in a direction to approach the pre-bending optical axis O1 from the left-side openings of these elongated open grooves T1 and T2 that face leftward. Each guide shaft 41A, 41B and 41C inserted into the associated elongated open groove T1 is fixed, at both ends thereof, inside the associated elongated open groove T1 by an adhesive, press-fitting or the like, and held so as not to come off the associated elongated open groove T1 by an outer surrounding wall 57 of the cover member 32.

As shown in FIGS. 4, 6, 8 and 9, each slidable support portion 51A, 51B and 51C is provided in the elongated open groove T2 thereof with a pair of projections 52 which face each other in a direction parallel to the pre-bending optical axis O1, and the pair of projections 52 of each slidable support portion 51A, 51B and 51C hold the associated guide shaft 41A, 41B or 41C therebetween from both sides thereof in a direction parallel to the pre-bending optical axis O1. Each pair of projections 52 project in opposite directions toward each other so as to partially narrow the width of the associated elongated open groove T2 in a direction parallel to the pre-bending optical axis O1 to hold the associated guide shaft 41A, 41B or 41C with substantially no clearance (specifically, with the presence of a minimum clearance allowing the associated slidable support portion 51A, 51B or 51C to slide on the associated guide shaft 41A, 41B or 41C). This structure prevents the first lens frame 30 from moving relative to the base member 31 in a direction along the pre-bending optical axis O1. Each projection 52 is shaped to taper toward the tip thereof (specifically, each pair of projections 52 are shaped to taper toward each other). On the other hand, the three guide shafts 41A, 41B and 41C are each cylindrical in outer peripheral shape and are in contact with the pairs of projections 52 of the three slidable support portions 51A, 51B and 51C at three support points (support locations) 45A, 45B and 45C shown in FIG. 7, respectively, as viewed from the front or rear. At each of the three support points 45A, 45B and 45C, the pair of projections 52 that face each other abut against the associated guide shaft 41A, 41B or 41C, and therefore, the first lens frame 30 is supported at six points: the front three points support points 45A, 45B and 45C and the rear three support points 45A, 45B and 45C. Each projection 52 is slidable on the associated guide shaft 41A, 41B or 41C via the support point 45A, 45B or 45C in a direction along a plane orthogonal to the pre-bending optical axis O1. The formation of each projection 52 into a tapered shape reduces the contacting area of each projection 52 with the associated guide shaft 41A, 41B or 41C, which makes it possible to reduce friction between each projection 52 and the associated guide shaft 41A, 41B or 41C when each projection 52 slides on the associated guide shaft 41A, 41B or 41C. The contacting area of each projection 52 with the associated guide shaft 41A, 41B or 41C can be minimized by tapering the end of each projection 52; however, from the viewpoint of ease in dimensional control during manufacture, the contact portion of each projection 52 which is in contact with the associated guide shaft 41A, 41B or 41C can be formed as a flat surface (the upper base of a trapezoid) lying in a plane substantially orthogonal to the pre-bending optical axis O1. In this case also, it is desirable to reduce the width of the end of each projection 52 as small as possible. FIG. 7 shows the positions of the support points 45A, 45B and 45C in the anti-shake initial state. When the first lens frame 30 moves relative to the base member 31 to reduce image shake from the anti-shake initial state, the position of each support point 45A, 45B and 45C relative to the pre-bending optical axis O1 varies; however, the relative positions between the support points 45A, 45B and 45C remain substantially constant.

It is possible to change the shape of each projection 52 of each slidable support portion 51A, 51B and 51C. For instance, each projection 52 of each slidable support portion 51A, 51B and 51C can take a semi-cylindrical outer surface shape.

As shown in FIG. 7, a clearance D1 is provided on each opposite side of each slidable support portion 51A, 51B and 51C, in the sliding direction thereof, with respect to the associated (adjacent) guide support portion 40A, 40B or 40C to allow each slidable support portion 51A, 51B and 51C to move in the axial direction of the associated guide shaft 41A, 41B or 41C. In addition, as shown in FIGS. 8 and 9, a clearance D2 is provided in the elongated open groove T2 of each slidable support portion 51A, 51B and 51C between the base of this elongated open groove T2 and the associated guide shaft 41A, 41B or 41C inserted therein to allow each slidable support portion 51A, 51B and 51C to move in the direction of depth of the elongated open groove T2 that is orthogonal to the axis of the associated guide shaft 41A, 41B or 41C. Namely, the slidable support portions 51A, 51B and 51C are supported to be movable along a plane orthogonal to the pre-bending optical axis O1 via the guide shafts 41A, 41B and 41C, respectively, that are fixedly supported on the base member 31.

The flange 55 of the first lens frame 30 is provided with the aforementioned movement limit hole 53. The movement limit hole 53 is formed through the flange 55 in the forward/rearward direction, and the movement limit projection 43 of the base member 31 is inserted into the movement limit hole 53. The movement limit hole 53, together with the movement limit projection 43, constitutes the aforementioned limit portion, which defines the range of movement of the first lens frame 30 relative to the base member 31. As shown in FIG. 7, the inner wall of the movement limit hole 53 is generally rectangular in shape in a plane substantially orthogonal to the pre-bending optical axis O1. The first lens frame 30 can move relative to the base member 31 within a range until the movement limit projection 43 comes into contact with the inner wall of the movement limit hole 53. The aforementioned clearances D1 and D2 that are set in each slidable support portion 51A, 51B and 51C are set to be greater than the moving range of the first lens frame 30 that is allowed by the movement limit hole 53 and the movement limit projection 43, and the moving range of the first lens frame 30 relative to the base member 31 is determined by the movement limit projection 43 and the movement limit hole 53. In the anti-shake initial state, the first lens frame 30 is positioned at the center in the range of movement thereof, which is defined by the movement limit projection 43 and the movement limit hole 53.

The first lens frame 30 is further provided with the aforementioned pivot support groove 54, in which the swing pivot 44 of the base member 31 is engaged. The pivot support groove 54 is an elongated groove which is elongated in a radial direction, centered at the pre-bending optical axis O1, and exposed radially outwards, toward the outer periphery of the first lens frame 30. The pivot support groove 54, together with the swing pivot 44, constitutes the aforementioned second guide portion, which is for defining the moving direction of the first lens frame 30 relative to the base member 31. As shown in FIG. 7, the pivot support groove 54 is engaged with the swing pivot 44 with a clearance allowing the pivot support groove 54 to move relative to the swing pivot 44 in the lengthwise (depthwise) direction of the pivot support groove 54, and the pivot support groove 54 is prevented from moving relative to the swing pivot 44 in a direction orthogonal to the lengthwise direction of the pivot support groove 54. Although the first lens frame 30 is supported by the base member 31 to be movable in a plane orthogonal to the pre-bending optical axis O1 due to the sliding engagement of the slidable support portions 51A, 51B and 51C with the slidable support portions 51A, 51B and 51C as mentioned above, the moving direction of the first lens frame 30 in the aforementioned orthogonal plane is defined by the engagement of the swing pivot 44 with the pivot support groove 54. Specifically, the first lens frame 30 is supported by the base member 31 to be allowed to move linearly in the lengthwise direction of the pivot support groove 54 (this linear moving operation is shown by a double-headed arrow J1 shown in FIG. 7) and swing (rotate) about the swing pivot 44 (this swinging operation is shown by a double-headed arrow J2 shown in FIG. 7).

The movement limit projection 43 and the swing pivot 44 are inserted into the movement limit hole 53 and the pivot support groove 54, respectively, at a stage when the first lens frame 30 is mounted on the base member 31 and before the installation of the guide shafts 41A, 41B and 41C.

As shown in FIG. 4, the cover member 32 is provided with a plate-shaped front wall 56 which is orthogonal to the pre-bending optical axis O1 and the outer surrounding wall 57 that projects rearward from the front wall 56. The cover member 32 is fixed onto the base member 31 so that the front wall 56 covers the first lens frame 30 from the front. In this fixed state, the outer surrounding wall 57 is a U-shaped wall that surrounds the three guide support portions 40A, 40B and 40C of the base member 31 from the outer side, and the side openings of the elongated open grooves T1 of the guide support portions 40A, 40B and 40C and the side openings of the elongated open grooves T2 of the slidable support portions 51A, 51B and 51C are all closed by the outer surrounding wall (see FIG. 3). The front wall 56 is provided with a photographic aperture 58, through which the first lens element L1 is exposed forward (toward the object side).

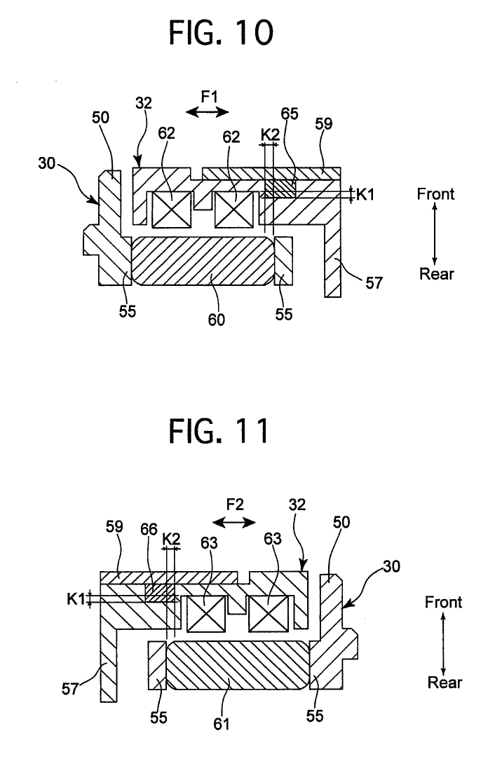

The first lens frame 30 is driven by an electromagnetic actuator. This electromagnetic actuator includes two voice coil motors (VCMs) provided with two permanent magnets 60 and 61 and two coils 62 and 63, respectively. The two permanent magnets 60 and 61 are supported by the first lens frame 30 and the two coils 62 and 63 are supported by the cover member 32. The permanent magnets 60 and 61 are fitted into and held by magnet holding holes formed in the flange 55 of the first lens frame 30 (see FIGS. 10 and 11). Each of the permanent magnets 60 and 61 is in the shape of a rectangular thin plate. The permanent magnets 60 and 61 are substantially identical in shape and size to each other and are arranged symmetrically with respect to the first reference plane P1. More specifically, opposite sides of a magnetic pole boundary line Q1 (see FIG. 7) of the permanent magnet 60 are magnetized into north and south poles, respectively, while opposite sides of a magnetic pole boundary line Q2 (see FIG. 7) of the permanent magnet 61 are magnetized into north and south poles, respectively. In other words, the magnetic pole boundary line Q1 defines a boundary between north and south poles of the permanent magnet 60, while the magnetic pole boundary line Q2 defines a boundary between north and south poles of the permanent magnet 61. The magnetic pole boundary line Q1 of the permanent magnet 60 and the magnetic pole boundary line Q2 of the permanent magnet 61 are inclined to each other so that the distance therebetween (i.e., the distance from the first reference plane P1) gradually increases in a direction from left to right. The inclination angles of the magnetic pole boundary lines Q1 and Q2 of the permanent magnets 60 and 61 with respect to the first reference plane P1 are set to approximately ±45 degrees, respectively. Namely, the permanent magnets 60 and 61 are arranged so that the magnetic pole boundary lines Q1 and Q2 are substantially orthogonal to each other.

As shown in FIG. 4, a circuit board 59 is fixed to a portion of the front wall 56 of the cover member 32 which does not overlap the photographic aperture 58. As shown in FIGS. 10 and 11, the coils 62 and 63 that constitute elements of the electromagnetic actuator are fixed to the rear side of the front wall 56 and are electrically connected to the circuit board 59. As shown in FIG. 7, each of the coils 62 and 63 is an air-core coil which includes a pair of linear portions that are substantially parallel to each other and a pair of curved (U-shaped) portions which connect the pair of linear portions at the respective ends thereof. The coils 62 and 63 are substantially identical in shape and size to each other and are symmetrically arranged with respect to the first reference plane P1. Specifically, in the anti-shake initial state, the long axis (major axis) of the coil 62, which is parallel to the linear portions of the coil 62 and passes through the air core of the coil 62, and the long axis (major axis) of the coil 63, which is parallel to the linear portions of the coil 63 and passes through the air core of the coil 63, substantially correspond to the magnetic pole boundary line Q1 of the permanent magnet 60 and the magnetic pole boundary line Q2 of the permanent magnet 61, respectively, as viewed from the front, as shown in FIG. 7. In other words, the coils 62 and 63 are arranged to be inclined to each other so that the distance between the long axis of the coil 62 and the long axis of the coil 63 gradually increases in a direction from left to right, similar to the permanent magnets 60 and 61. The inclination angles of the long axes of the coils 62 and 63 with respect to the first reference plane P1 are set to approximately ±45 degrees, respectively. Namely, the coils 62 and 63 are arranged so that the lengthwise directions (the long axes) thereof are substantially orthogonal to each other.

The energization of the coils 62 and 63 is controlled via the circuit board 59. A driving force is generated in a direction substantially orthogonal to the magnetic pole boundary line Q1 of the permanent magnet 60 (i.e., orthogonal to the direction of the long axis of the coil 62) in a plane orthogonal to the pre-bending optical axis O1 upon the coil 62 being energized. The direction of action of this driving force is shown by a double-headed arrow F1 in FIGS. 7 and 10. On the other hand, a driving force is generated in a direction substantially orthogonal to the magnetic pole boundary line Q2 of the permanent magnet 61 (i.e., orthogonal to the direction of the long axis of the coil 63) in a plane orthogonal to the pre-bending optical axis O1 upon the coil 63 being energized. The direction of action of this driving force is shown by a double-headed arrow F2 in FIGS. 7 and 11. The direction of action F1 of the driving force generated by energizing the coil 62 is substantially parallel to the lengthwise direction of the pivot support groove 54, and the first lens frame 30 performs the linear moving operation J1, in which the first lens frame 30 moves linearly along the lengthwise direction of the pivot support groove 54 relative to the base member 31, upon the coil 62 being energized. On the other hand, the direction of action F2 of the driving force generated by energizing the coil 63 is substantially orthogonal to the lengthwise direction of the pivot support groove 54, and the pivot support groove 54 is prevented from moving relative to the swing pivot 44 in this orthogonal direction, and accordingly, the first lens frame 30 performs the swinging operation J2, in which the first lens frame 30 rotates (swings) about the swing pivot 44 relative to the base member 31 of the first lens frame 30, upon the coil 63 being energized. The first lens frame 30 can be moved to any arbitrary position in a plane orthogonal to the pre-bending optical axis O1 with respect to the base member 31 by a combination of controlling the passage of current through the coils 62 and 63. As described above, the moving range of the first lens frame 30 with respect to the base member 31 is limited by engagement of the movement limit projection 43 with the inner wall of the movement limit hole 53.

Reference character U1 shown in FIG. 7 designates the centers of the permanent magnet 60 and the coil 62 (the centers of the outer shapes thereof) in a plane orthogonal to the pre-bending optical axis O1. Likewise, reference character U2 shown in FIG. 7 designates the centers of the permanent magnet 61 and the coil 63 (the centers of the outer shapes thereof) in a plane orthogonal to the pre-bending optical axis O1. Each permanent magnet 60 and 61 is substantially square in shape as viewed from front. The center U1 of the permanent magnet 60 corresponds to both the center of the permanent magnet 60 in a direction along the magnetic pole boundary line Q1 and the center of the permanent magnet 60 in a direction orthogonal to the magnetic pole boundary line Q1. The center U2 of the permanent magnet 61 corresponds to both the center of the permanent magnet 61 in a direction along the magnetic pole boundary line Q2 and the center of the permanent magnet 61 in a direction orthogonal to the magnetic pole boundary line Q2. The center U1 of the coil 62 corresponds to both the center of the coil 62 in the lengthwise (long-side) direction thereof along the long axis of the coil 62 and the center of the coil 62 in the short-side direction thereof that is orthogonal to the long axis of the coil 62. The center U2 of the coil 63 corresponds to both the center of the coil 63 in the lengthwise (long-side) direction thereof along the long axis of the coil 63 and the center of the coil 63 in the short-side direction thereof that is orthogonal to the long axis of the coil 63. In the anti-shake initial state that is shown in FIG. 7, the center U1 of the permanent magnet 60 and the center U1 of the coil 62 are coincident with each other (i.e., the center U1 of the permanent magnet 60 and the center U1 of the coil 62 are aligned in the forward/rearward direction), and the center U2 of the permanent magnet 61 and the center U2 of the coil 63 are coincident with each other (i.e., the center U2 of the permanent magnet 61 and the center U2 of the coil 63 are aligned in the forward/rearward direction). A movement of the first lens frame 30 which is caused by the passage of current through the coils 62 and 63 causes the positions of the centers U1 and U2 of the permanent magnets 60 and 61 with respect to the centers U1 and U2 of the coils 62 and 63 to change, respectively. As shown in FIG. 7, a first plane H1 which is parallel to the pre-bending optical axis O1 and extends in the direction of action F1 while passing through both the center U1 of the permanent magnet 60 and the center U1 of the coil 62 in the anti-shake initial state, and a second plane H2 which is parallel to the pre-bending optical axis O1 and extends in the direction of action F2 while passing through both the center U2 of the permanent magnet 61 and the center U2 of the coil 63 in the anti-shake initial state intersect each other at a point of intersection E on the first reference plane P1.

In addition, a magnetic sensor (first sensor) 65 and a magnetic sensor (second sensor) 66 are mounted to and supported by the rear of the circuit board 59 as shown in FIGS. 10 and 11. Each of the two magnetic sensors 65 and 66 is composed of a Hall sensor connected to the circuit board 59. As viewed from the front, as shown in FIG. 7, the magnetic sensor 65 is disposed on the opposite side of the coil 62 in the direction of action F1 from the first lens element L1 (on the side farther from the pre-bending optical axis O1) and is adjacent to the linear portion of the coil 62, and the magnetic sensor 65 and the coil 62 overlap each other as viewed in the direction of action F1 (see FIG. 10). Similarly, as viewed from front as shown in FIG. 7, the magnetic sensor 66 is disposed on the opposite side of the coil 63 in the direction of action F2 from the first lens element L1 side (on the side farther from the pre-bending optical axis O1) to be adjacent to the linear portion of the coil 63, and the magnetic sensor 66 and the coil 63 overlap each other as viewed in the direction of action F2 (see FIG. 11). The reference character K1 shown in FIG. 10 designates the overlapping range between the magnetic sensor 65 and the coil 62 and the reference character K1 shown in FIG. 11 designates the overlapping range between the magnetic sensor 66 and the coil 63.

When the cover member 32 is mounted to the base member 31, the magnetic sensors 65 and 66 are positioned in the vicinity of the permanent magnets 60 and 61, respectively. As shown in FIGS. 10 and 11, the magnetic sensors 65 and 66 are positioned in front of the permanent magnets 60 and 61, respectively, with respect to the forward/rearward direction of the imaging unit 10 along the pre-bending optical axis O1. As shown in FIG. 10, in the direction of action F1, the width of the permanent magnet 60 is greater than the width of the coil 62 in the short-side direction thereof so that both ends of the permanent magnet 60 project from both ends of the coil 62 in the direction of action F1, and one of the projecting ends of the permanent magnet 60 which is farther from the pre-bending optical axis O1 (farther from the first lens element L1) (i.e., the right end of the permanent magnet 60 with respect to FIG. 10) and the magnetic sensor 65 overlap each other as viewed from the front. As shown in FIG. 11, in the direction of action F2, the width of the permanent magnet 61 is greater than the width of the coil 63 in the short-side direction thereof so that both ends of the permanent magnet 61 project from both ends of the coil 63 in the direction of action F2, and one of the both projecting ends of the permanent magnet 61 which is farther from the pre-bending optical axis O1 (farther from the first lens element L1) (i.e., the left end of the permanent magnet 61 with respect to FIG. 11) and the magnetic sensor 66 overlap each other as viewed from front. The reference character K2 shown in FIG. 10 designates the overlapping range between the magnetic sensor 65 and the permanent magnet 60 and the reference character K2 shown in FIG. 11 designates the overlapping range between the magnetic sensor 66 and the permanent magnet 61.

As shown in FIG. 7, each of the two magnetic sensors and 66 has a narrow rectangular shape in a front orthographic projection, and the reference characters U3 and U4 shown in FIG. 7 designate the centers of the magnetic sensors 65 and 66 in a plane orthogonal to the pre-bending optical axis O1, respectively. The lengthwise direction of the magnetic sensor 65 is substantially parallel to the magnetic pole boundary line Q1 and the lengthwise direction of the magnetic sensor 66 is substantially parallel to the magnetic pole boundary line Q2. Variation in position of the permanent magnet 60 in accordance with movement of the first lens frame 30 that is caused by the electromagnetic actuator causes the output of the magnetic sensor 65 to vary, and variation in position of the permanent magnet 61 in accordance with movement of the first lens frame 30 that is caused by the electromagnetic actuator causes the output of the magnetic sensor 66 to vary. Hence, the position of the first lens frame 30 can be detected from the output variations of the two magnetic sensors 65 and 66. Upon start-up of the imaging unit 10, the calibration of each magnetic sensor 65 and 66 is performed by driving the first lens frame 30 to a moving end thereof defined by the movement limit projection 43 and the movement limit hole 53.

As shown in FIG. 7, the center U3 of the magnetic sensor 65 in a plane orthogonal to the pre-bending optical axis O1 lies in the first plane H1 which extends in the direction of action F1, and the center U4 of the magnetic sensor 66 in a plane orthogonal to the pre-bending optical axis O1 lies in the second plane H2 which extends in the direction of action F2. Although the centers U3 and U4 of the magnetic sensors 65 and 66 are spaced from the centers U1 and U2 of the permanent magnets 60 and 61 in the first plane H1 and the second plane H2, respectively, as shown in FIG. 7, since each magnetic sensor 65 and 66 is positioned close to the associated permanent magnet 60 or 61 to a degree to be partly included in the front orthographic projection area of the associated permanent magnet 60 or 61 as shown in FIGS. 10 and 11 as the overlapping range K2, the magnetic sensors 65 and 66 can achieve a sufficient detection accuracy.

In the first lens-group unit 12, the first lens frame 30, which supports the first lens element L1 and the permanent magnets 60 and 61, is a movable part that moves to reduce image shake, and the center of gravity of this movable part (in a plane orthogonal to the pre-bending optical axis O1) is designated by a reference letter Z in FIG. 7.

If the imaging unit 10, which is completely assembled by mounting the first lens-group unit 12 which has the above described structure to the body module 11, is pointed at an object located in front of the imaging unit 10, light reflected by the object (light emanating from a photographic object) enters the first prism L11 through the incident surface L11-a after passing through the first lens element L1 and is reflected at an angle of 90 degrees by the reflecting surface L11-c of the first prism L11 and travels toward the exit surface L11-b. Subsequently, the reflected light that emerges from the exit surface L11-b of the first prism L11 enters the second prism L12 from the incident surface L12-a after passing through the second lens element L2, the second lens group G2, the third lens group G3 and the fourth lens group G4, and is reflected at an angle of 90 degrees by the reflecting surface L12-c of the second prism L12 and travels toward the exit surface L12-b. Subsequently, the reflected light emerges from the exit surface L12-b and is captured (received) by the imaging surface of the image sensor IS. A zooming operation of the imaging optical system of the imaging unit 10 is performed by moving the second lens group G2 and the third lens group G3 along the pair of rods 22 and 23 using the first motor M1 and the second motor M2. A focusing operation of the imaging optical system of the imaging unit 10 is performed by moving the third lens group G3 along the pair of rods 22 and 23 using the second motor M2. By performing these zooming and focusing operations, focused object images can be captured at selected angle of view.

Additionally, in the imaging unit 10, an anti-shake (image shake correction/ image-stabilizing/shake reduction) operation is performed using the first lens element L1 of the first lens group G1 that is positioned in front of the first prism L11. As described above, the anti-shake system supports the first lens frame 30 in a manner to allow the first lens frame 30 to move relative to the base member 31, which is fixed with respect to the housing 13, in a plane orthogonal to the pre-bending optical axis O1 (in a plane orthogonal to the second reference plane P2) and drives the first lens frame 30 using the electromagnetic actuator.

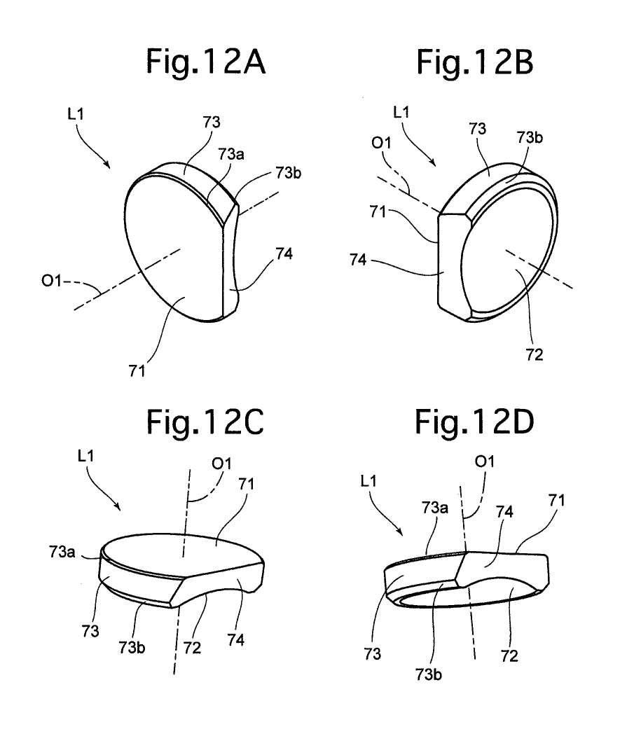

The present embodiment teaches a novel shape of the first lens group G1 in the above described imaging apparatus. FIGS. 12A, 12B, 12C and 12D only show the shape of the first lens element (front lens group) L1 of the first lens group G1. The first lens element L1 is formed as a single lens element; more specifically, a glass lens element provided with an incident surface 71, an exit surface 72, a partial-cylindrical surface 73 and a cut surface (inclined flat surface) 74. The partial-cylindrical surface 73 is rotationally symmetrical about the optical axis of the first lens element L1 (the optical axis of the first lens element L1 being aligned with the pre-bending optical axis O1 when in the anti-shake initial state), and the cut surface 74 is formed on a portion of the outer edge of the first lens element L1 on the side near the second lens element L2, which serves as a rear lens group of the imaging optical system of the imaging unit 10. The first lens element L1 is provided, on the edge of the cylindrical surface 73 on the incident surface 71 side, with a small-chamfered portion 73a and is provided, on the edge of the circular surface 73 on the exit surface 72 side, with a large-chamfered portion 73b. The small-chamfered portion 73a and the large-chamfered portion 73b are made simultaneously with the exit surface 72 and the cylindrical surface 73. The first lens element L1 is made by glass molding or spherical grinding, and the molds for use in glass-molding the first lens element L1 consist of a pair of molds in which cavities corresponding to the incident surface 71, the exit surface 72 and the cylindrical surface 73 are formed. In the case where the first lens element L1 is made by spherical grinding, the cylindrical surface 73 is formed by grinding the rim of the lens element while rotating the lens element about the optical axis thereof with the incident surface 71 and the exit surface 72 clamped. In this embodiment, the incident surface 71 is formed into either a flat surface or a concave or convex surface with a small curvature (i.e., a near-flat surface), and the exit surface 72 is formed into a concave surface.

The cut surface 74 is formed into an inclined flat surface which lies in a plane that is orthogonal to the first reference plane P1. The cut surface 74 is also inclined with respect to the second reference plane P2 to approach the second reference plane P2 in a direction from the incident surface 71 to the exit surface 72 (i.e., the rearward direction) and does not intersect (does not reach) the post-bending optical axis O2. After a rotationally-symmetrical lens element that is rotationally symmetrical with respect to its optical axis (the pre-bending optical axis O1) is made by the aforementioned glass molding or spherical grinding, the cut surface 74 is made by grinding a portion of the outer periphery (rim) of the rotationally-symmetrical lens element. The angle a (see FIG. 9) between the cut surface 74 and the second reference plane P2 (the pre-bending optical axis O1) in the first reference plane P1, which is orthogonal to the second reference plate P2 and includes both the pre-bending optical axis O1 and the post-bending optical axis O2, is desirably in the range of 10 to 30 degrees. If the angle a is greater than 30 degrees, a large chip(s) may occur at the edge of the incident surface 71 because of the edge of the incident surface 71 being excessively acute, and the effective optical surface on the exit surface 72 side becomes narrow. If the angle a is smaller than 10 degrees, no clearance is formed between the first lens element L1 and the second lens element L2.

The edge of the cut surface 74 on the incident surface 71 side directly intersects with the incident surface 71 with no inclined chamfered surface therebetween, and a linear border is defined between the cut surface 74 and the incident surface 71. Likewise, the edge of the cut surface 74 on the exit surface 72 side directly intersects with the exit surface 72 with no inclined chamfered surface therebetween, and a linear border is defined between the cut surface 74 and the exit surface 72. Hence, the edge of the cut surface 74 at the incident surface 71 and at the exit surface 72 stands in contrast to the formation of the small-chamfered portion 73a and the large-chamfered portion 73b on the outer edge of the cylindrical surface 73 on the incident surface 71 side except for the cut surface 74 and the outer edge of the cylindrical surface 73 on the exit surface 72 side, respectively. By making the edge of the cut surface 74 directly intersect the incident surface 71 without any inclined chamfered surface therebetween and by making the edge of the cut surface 74 directly intersect the exit surface 72 without any inclined chamfered surface therebetween as described above, it becomes possible to enlarge the effective optical surface of the first lens element L1 up to the immediate area at the edges (at the incident surface 71 side and the exit surface 72 side) of the cut surface 74, thus contributing to miniaturization (reduction in diameter). In other words, the formation of a chamfer(s) is disadvantageous to miniaturization (reduction in diameter) because no light rays can pass therethrough (a chamfer cannot be made to serve as an effective optical surface for image formation).

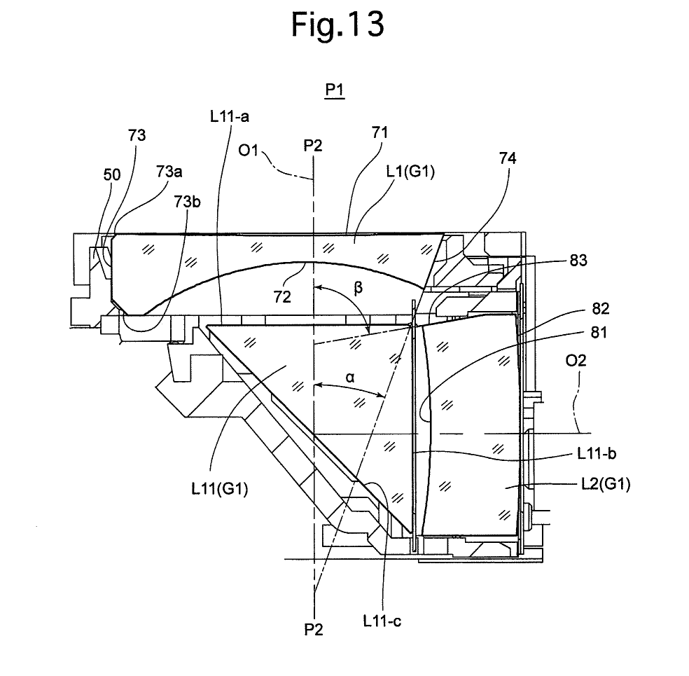

FIG. 13 is an enlarged sectional view of the first lens group G1. Among the optical elements of the first lens group G1, the second lens element (rear lens group, immediately-rearward lens element) L2, which is positioned immediately behind the first prism L11 (and the closest to the first prism L11), is a lens element which is formed by cutting the upper and lower ends, with respect to FIG. 13, of a rotationally-symmetrical lens element that is rotationally symmetrical about the post-bending optical axis O2 (whether this lens element is a plastic lens or a glass lens is optional). The edge surface 83 of the second lens element L2 (i.e., the outer peripheral surface of the second lens element L2 that connects the incident surface 81 and the exit surface 82), at least an area of this outer peripheral surface in the vicinity of the cut surface 74, is formed into a tapered surface which tapers in a direction toward the first prism L11 along the post-bending optical axis O2 (i.e., progressively widens in a direction toward the second lens group G2 along the post-bending optical axis O2).

The angle p between the pre-bending optical axis O1 and the edge surface 83 of the second lens element L2 in the first reference plane P1, which includes the pre-bending optical axis O1 and the post-bending optical axis O2, is set to be equal to or smaller than 90 degrees. The smaller the angle β, the higher the effect of preventing the first lens element L1 and the second lens element L2 from interfering with each other is; however, in practice, it is desirable that the angle β be approximately 80 degrees±5 degrees. If the angle β exceeds the upper limit (i.e., 85 degrees), the aforementioned effect is reduced. If the angle p exceeds the lower limit (i.e., 75 degrees), the effective optical surface becomes excessively small, which adversely affects (reduction in amount of light collected through the periphery of the lens) the imaging performance.

Since the first lens element L1 is reduced in weight and size, the present invention is desirably applicable particularly to an imaging apparatus which is equipped with an anti-shake system (image stabilizer) that drives (moves), in accordance with vibrations exerted on the imaging apparatus, the front lens group (the first lens element L1) in directions intersecting the pre-bending optical axis O1 including a direction component that is orthogonal to the pre-bending optical axis O1.

In the above illustrated embodiment of the imaging apparatus, it is desirable that the first lens element L1, which is positioned in front of the bending optical element L11, be a single lens element, the exit surface 72 of which is a concave surface. Furthermore, the first lens element L1 can be made out of glass or plastic.

Although the second lens group G2, the third lens group G3 and the fourth lens group G4 are provided on the post-bending optical axis O2 in the above illustrated embodiment of the imaging apparatus, the present invention can also be applied to an imaging optical system in which less than or more than three lens groups are provided on the post-bending optical axis O2.

Additionally, in the first lens group G1, it is possible to change the number of lens elements arranged in front (on the object side) of the incident surface L11-a of the first prism L11 on the pre-bending optical axis O1 and the number of lens elements arranged on the right-hand side (image side) of the exit surface L11-b of the first prism L11 on the post-bending optical axis O2. Additionally, although the second lens element L2, which is arranged on the right-hand side (image side) of the first prism L11, is a single lens element in the above illustrated embodiment, the second lens element L2 can be a lens group including a plurality of lens elements. Additionally, it is possible to modify the first lens group G1 so as not to include any lens element (i.e., the second lens element L2) on the optical path extending from the exit surface L11-b of the first prism L11 toward the second lens group G2.

The length of the optical path from the incident surface of the first lens element L1 to the image plane in the imaging unit 10 is constant at all times in the above described embodiment. In this type of imaging optical system, the frontmost lens group (the first lens element L1), which is the closest to the object side, is generally a negative lens element. However, the frontmost lens group in the imaging apparatus according to the present invention, i.e., the first lens element (front lens group) L1 can be a positive lens element. Regardless of whether the power of the front lens group (frontmost lens group) is negative or positive, any lens element can be adopted as the front lens group so long as it has a refractive power.

Additionally, although the imaging optical system of the above illustrated embodiment of the imaging unit 10 is a zoom lens (variable power optical system) which performs a zooming operation (power varying operation) by moving the second lens group G2 and the third lens group G3 along the post-bending optical axis O2, the present invention is also applicable to an imaging apparatus which incorporates an imaging optical system having no power varying capability. For instance, it is possible to modify the imaging unit 10 such that the second lens group G2 and the third lens group G3 do not move for a zooming operation and that the second lens group G2 or the third lens group G3 moves solely for a focusing operation.

Although the incident surface L11-a of the first prism L11 in the above illustrated embodiment of the imaging apparatus is in the shape of a laterally elongated rectangle, the present invention can also be applied to a type of imaging apparatus having a first prism (which corresponds to the first prism L11) in which the incident surface thereof has a different shape such as a square or a trapezoid. In addition, the present invention can also be applied to a type of imaging apparatus which is not provided with a second prism (such as a prism corresponding to the second prism L12).

Obvious changes may be made in the specific embodiment of the present invention described herein, such modifications being within the spirit and scope of the invention claimed. It is indicated that all matter contained herein is illustrative and does not limit the scope of the present invention.

1. An imaging apparatus comprising a bending optical element, a front lens group and a rear lens group,
wherein said front lens group and said rear lens group are provided on a pre-bending optical axis and a post-bending optical axis of said bending optical element, respectively,
wherein said front lens group includes a cut surface which is formed as an inclined flat surface on a portion of an outer edge of said front lens group on a side near said rear lens group, said inclined flat surface lying on a plane that is orthogonal to a first reference plane, which includes said pre-bending optical axis and said post-bending optical axis, and
wherein said inclined flat surface is inclined to a second reference plane, which is orthogonal to said first reference plane and includes said pre-bending optical axis, to approach said second reference plane in a direction from an incident surface of said front lens group to an exit surface thereof.

2. The imaging apparatus according to claim 1, wherein an angle between said inclined flat surface and said second reference plane is in a range of 10 through 30 degrees in said first reference plane.

3. The imaging apparatus according to claim 1, wherein said rear lens group comprises an immediately-rearward lens element which is positioned immediately behind said bending optical element, and
wherein an angle between an edge surface of said immediately-rearward lens element and said second reference plane is one of equal to and smaller than 90 degrees in said first reference plane.

4. The imaging apparatus according to claim 1, wherein said front lens group comprises a glass lens element.

5. The imaging apparatus according to claim 1, wherein said outer edge of said front lens group except said portion thereof is formed as a partial-cylindrical surface about the optical axis of said front lens group.

6. The imaging apparatus according to claim 1, wherein said inclined flat surface and each of said incident surface and said exit surface of said front lens group directly intersect with each other without an inclined chamfered surface therebetween, and
wherein a linear border is defined between said inclined flat surface and said incident surface of said front lens group and a linear border is defined between said inclined flat surface and said exit surface of said front lens group.

7. The imaging apparatus according to claim 1, wherein said imaging apparatus comprises an anti-shake system which drives said front lens group in directions intersecting said pre-bending optical axis, said directions including a direction component that is orthogonal to said pre-bending optical axis.

8. The imaging apparatus according to claim 1, wherein said front lens group consists of a single lens element having a concave exit surface.
